(19) United States
(12) Patent Application Publication
(10) Pub. No.: US 2018/0223758 A1
(43) Pub. Date: Aug. 9, 2018

(54) MACHINE SYSTEM HAVING FLUID SHUTOFF VALVE, AND METHOD

(71) Applicant: Caterpillar Inc., Peoria, IL (US)

(72) Inventors: Joseph Stabnik, Rensselaer, IN (US); Aaron Hartzler, Lafayette, IN (US); Rodney Lawrence, Frankfort, IN (US); Ryan Brown, West Lafayette, IN (US)

(73) Assignee: Caterpillar Inc., Peoria, IL (US)

(21) Appl. No.: 15/428,058

(22) Filed: Feb. 8, 2017

(51) Int. Cl. F02D 41/04; F02D 41/22; F02M 35/10; F02D 9/10

(52) U.S. Cl. CPC F02D 41/042; F02D 41/22; F02D 9/101; F02D 9/1045; F02D 9/107; F02M 35/10373

(57) ABSTRACT

A machine system includes a machine, a fluid conduit connected with the machine, and a shutoff valve. The shutoff valve includes a gate swingable through a fluid flow path through the fluid conduit between an open position and a closed position to interrupt a flow of fluid through the fluid conduit to the machine. In an embodiment the machine includes an engine and the fluid conduit includes an air intake conduit such that shutting off the flow of fluid shuts down the engine.

### TECHNICAL FIELD

The present disclosure relates generally to machine systems employing a fluid shutoff valve, and more particularly to such a system employing a shutoff valve having a swinging gate.

### BACKGROUND

All manner of shutoff valves are used in fluid systems to controllably interrupt flow of fluid to a target. Interruption of the flow may be for purposes of avoiding overfilling of a storage vessel or the like, halting draining, or for a variety of other purposes. In the context of an engine system, it can be desirable to provide a mechanism for rapidly shutting off a supply of air to the engine. Various strategies for engine shutdown generally, have been proposed over the years. It has been observed, however, that starving the engine of air is commonly the most effective and reliable way to stop operation quickly.

Engines operating in certain environments where combustible gases are present can present a particular need for rapid engine shutdown. For example, at a wellhead combustible gases such as natural gas can sometimes leak or otherwise escape from a bore hole or containment vessel. Engines operating in such environments can end up being supplied with extra fuel in the form of natural gas entering the air intake system, having undesirable consequences such as engine overspeeding. In other instances, engines can overspeed on other combustible fuels such as wood chips, alcohol, gasoline vapors, hydrogen, and in enriched oxygen atmospheres, or even on the own oil supply or diesel fuel supply such as in the case of a stuck fuel rack or the like.

United States Patent Application Publication No. 20150315983 relates to a method and apparatus for shutting down an engine by selectively preventing air from passing into the air intake. According to the '983 publication, a valve in the nature of a butterfly valve is electromagnetically actuated to move to a closed position to prevent air from passing into the engine air intake once one or more predetermined engine conditions have been detected. While the disclosed strategy may have certain applications, there are likely disadvantages relating to reliability and/or the obstruction of the fluid pathway by way of the shaft and/or plate of the butterfly valve.

### SUMMARY OF THE INVENTION

In one aspect, a machine system includes a machine, and a fluid conduit defining a fluid flow path, the fluid flow path extending between an inlet and an outlet fluidly connected with the machine. The machine system further includes a shutoff valve having a gate, and a hinge defining a hinge axis within the fluid flow path and supporting the gate at a location that is spaced radially outward of the hinge axis. The gate is swingable through the fluid flow path and about the hinge axis between an open position, at which the fluid inlet is in fluid communication with the fluid outlet, and a closed position, at which the gate blocks the fluid communication to interrupt a flow of fluid through the fluid conduit to the machine.

In another aspect, a flow shutoff valve for a machine system includes a valve housing having an upstream end and a downstream end, and a fluid passage being formed in the valve housing and extending between the upstream end and the downstream end. A hinge is positioned at least partially within the valve housing and defines a hinge axis that extends through the fluid passage. The flow shutoff valve further includes a gate supported by the hinge at a location radially outward of the hinge axis and between the upstream end and the downstream end. The gate is swingable through the fluid passage and about the hinge axis between an open position and a closed position, and the gate blocking fluid communication through the fluid passage at the closed position to interrupt a flow of fluid through the fluid shutoff valve to the machine.

In still another aspect, a method of operating a machine system includes conveying a fluid through a flow path formed by a fluid conduit coupled with a machine, and swinging a gate of a shutoff valve from an open position to a closed position within the fluid conduit about a hinge defining a hinge axis that extends through the flow path. The method further includes shutting off the flow of fluid to the machine by way of the swinging of the gate from the open position to the closed position.

### BRIEF DESCRIPTION OF THE DRAWINGS

FIG. 1 is a diagrammatic view of a machine system, according to one embodiment;

FIG. 2 is a side diagrammatic view, in perspective, of a shutoff valve, according to one embodiment;

FIG. 3 is a sectioned side diagrammatic view of the shutoff valve of FIG. 2;

FIG. 4 is a sectioned side diagrammatic view of a shutoff valve, according to one embodiment, in an open position;

FIG. 5 is a sectioned side diagrammatic view of the shutoff valve of FIG. 4 in a partially closed position;

FIG. 6 is a sectioned side diagrammatic view of the shutoff valve of FIGS. 4 and 5 in a closed position;

FIG. 7 is a side diagrammatic view, in perspective, of a gate for a shutoff valve, according to one embodiment;

FIG. 8 is a side diagrammatic view, in perspective, of a gate for a shutoff valve, according to another embodiment; and

FIG. 9 is a diagrammatic view of a gate for a shutoff valve, according to yet another embodiment.

### DETAILED DESCRIPTION

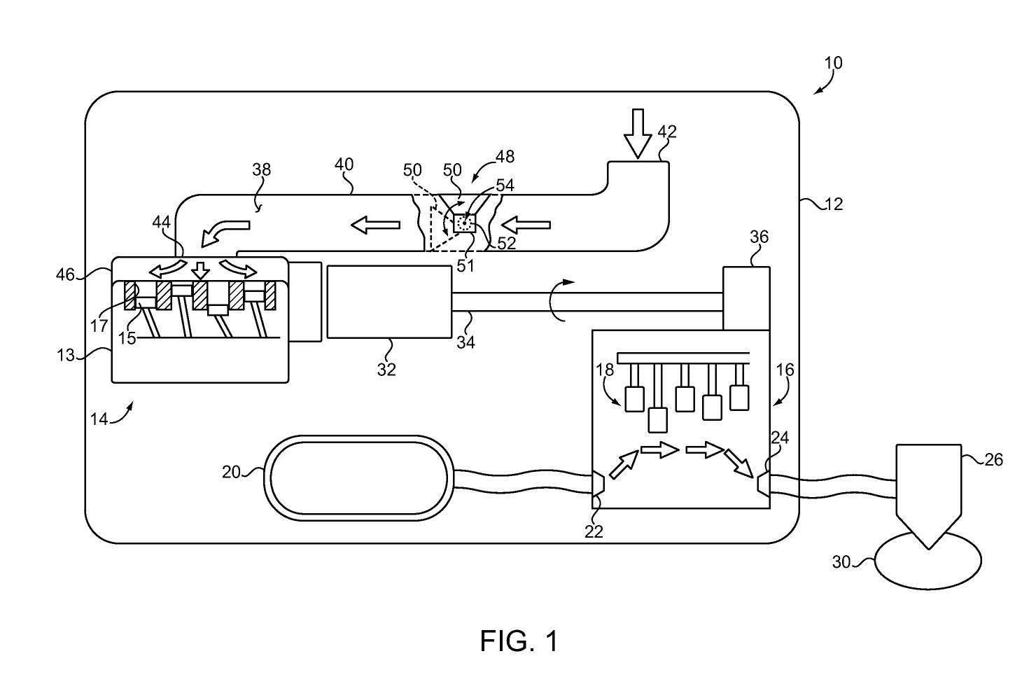

Referring to FIG. 1, there is shown a machine system 10 according to one embodiment, and illustrated in the context of a frac rig having a frame 12 and a plurality of different components mounted upon or associated with frame 12. In one embodiment, frame 12 includes a trailer or the bed of a truck or the like, such that machine system 10 is equipped for mobile frac operations. In other instances, frame 12 might consist of a stationary pad at a wellhead, or no frame at all might be provided. The present disclosure is furthermore applicable outside of the context of fracking or other oil and/or gas operations, as will be further apparent from the following description. Machine system 10 further includes a machine 14 such as an internal combustion engine having an engine housing 13 with a plurality of cylinders 17 formed therein, and pistons 15 reciprocable within cylinders 17 in a generally conventional manner. Machine or engine 14 (hereinafter “engine 14”) may be coupled with a transmission 32 operable to rotate a driveshaft 34 coupled with a gearbox 36. Gearbox 36 may be coupled with a pump 16 having a plurality of pumping elements therein movable to transition a fluid between a pump inlet 22 and a pump outlet 24. In the illustrated embodiment, a fluid supply 20, such as a fluid supply containing a fracking fluid, is coupled with pump 16, and the fracking fluid pressurized by way of pump 16 is conveyed to an injector 26 associated with a borehole 30 in a generally conventional manner. Machine system 10 further includes a fluid conduit 40 defining a fluid flow path 38 extending between an inlet 42 and an outlet 44 fluidly connected with cylinders 17 in engine 14 by way of an intake manifold 46.

It has been observed that engines operating in certain environments such as at oil and gas wells are desirably equipped with apparatus for shutdown by way of restricting air supply to the engine. Combustible gases or even other fluids in certain environments can enter an engine air intake system, and be conveyed into an engine where they combust, resulting in overspeeding the engine or causing other problems. Certain existing systems can effectively shut off air to an engine in such instances, however, vibrations, wear, corrosion or other factors can lead known valve mechanisms for interrupting airflow to operate unpredictably or unnecessarily. In a fracking operation, or other applications, unplanned engine shutdown can be highly undesirable.

Machine system 10 further includes a shutoff valve 48 to interrupt a flow of fluid, such as air and/or air and combustible gases or still other gases or mixtures of gases, to engine 14. Shutoff valve 48 includes a gate 50, and a hinge 52 defining a hinge axis 54 within fluid flow path 38, and hinge 52 supporting gate 50 at a location that is spaced radially outward of hinge axis 54. In FIG. 1 fluid conduit 40 is shown open to illustrate gate 50 approximately as it might appear in an open position, movable to a closed position shown in phantom. It should be appreciated that the geometry of gate 50 as illustrated in FIG. 1 is diagrammatic only. A variety of alternative shapes and gate configurations are contemplated within the context of the present disclosure. An actuator 51 may be coupled with hinge 52 or otherwise structured to swing gate 50 between the closed position and the open position. It is contemplated that gate 50 may be spring loaded to close, and actuator 51 could include a linear actuator or a rotary actuator structured to move a pin, a catch, or some other element that maintains gate 50 otherwise in an open position. In still other instances, actuator 51 might operate to controllably swing gate 50 from the open position to the closed position. Actuator 51 might be coupled with an engine control system of engine 14, for example, and structured to operate such that gate 50 swings to the closed position when one or more predefined operational or environmental parameters are detected. The operational or environmental parameters might include, for example, an engine speed indicative of an overspeed condition, the presence of combustible gas, or the failure of associated equipment.

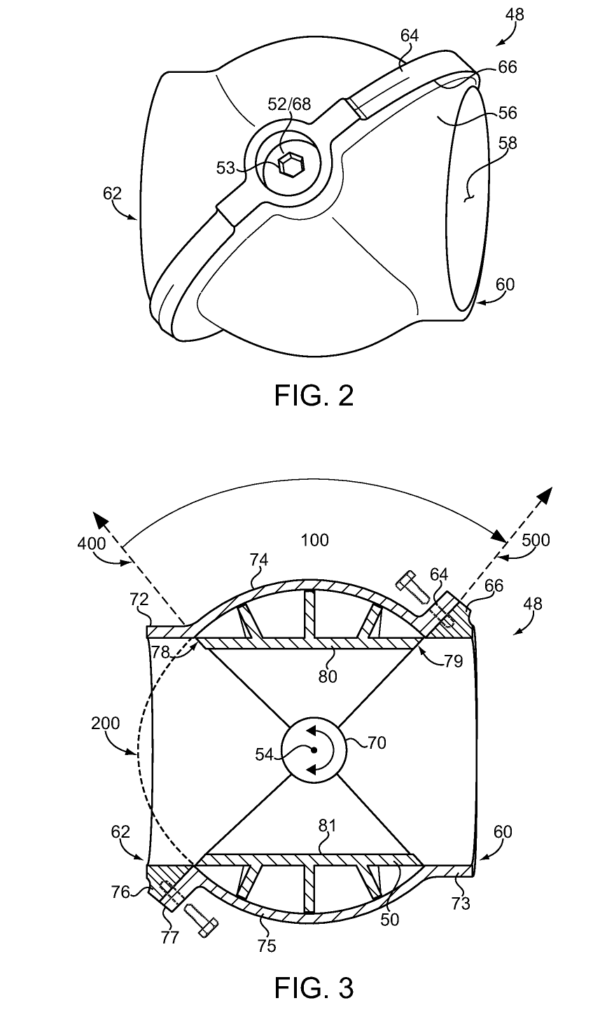

Referring also now to FIG. 2, and FIG. 3, gate 50 is swingable through fluid flow path 38 and about hinge axis 54 between an open position, at which fluid inlet 42 and fluid outlet 44 are in fluid communication with one another, and a closed position, at which gate 50 blocks the fluid communication to interrupt the flow of fluid through fluid conduit 40 to engine 14. Shutoff valve 48 further includes a valve housing 56, and a fluid passage 58 that forms a segment of fluid flow path 38 and extends through valve housing 56 between an upstream valve housing end 60 and a downstream valve housing end 62. As depicted in FIG. 3, when gate 50 is at the open position fluid passage 58 is unobstructed by gate 50. It will be recalled that hinge axis 54 is within fluid flow path 38, and within fluid passage 58. In FIG. 2 and FIG. 3 hinge axis 54 would be understood to extend in and out of the page, at least approximately, and across a width of fluid passage 58. It can also be seen from FIG. 2 that a cutout 53 or the like may be formed in hinge 52 to enable coupling with an actuator or other equipment used in operating valve 50.

In the illustrated embodiment valve housing 56 includes a first housing piece 64 and a second housing piece 66. Hinge 52 includes a first hinge element 68 and a second hinge element 70 positioned upon opposite sides of fluid passage 58 and thus upon opposite sides of fluid flow path 38. Each of first hinge element 68 and second hinge element 70 may be clamped between first housing piece 64 and second housing piece 66. Each of first housing piece 64 and second housing piece 66 may further include a cylindrical pipe section 72 and 73, respectively, for coupling with fluid conduit 40. In other embodiments each pipe section 72 and 73 might have a shape other than cylindrical. Analogously gate 50 and the other gates contemplated herein can have many different shapes. Each of first housing piece 64 and second housing piece 66 may further include, respectively, a domed body 74 and 75, and a connecting flange 76 and 77, for attaching to the connecting flange of the other of first housing piece 64 and second housing piece 66. In other embodiments, only one of housing piece 64 and housing piece 66, or housing pieces of alternative configurations, might include a domed body. In a practical implementation strategy, gate 50 is swingable in an arcuate path indicated by way of reference numeral 200 in FIG. 3 that is parallel to an arc defined by a shape of the corresponding domed body 74, 75, the significance of which will be further apparent from the following description. In a further practical implementation strategy first housing piece 64 and second housing piece 66 may be substantially identical, and even have the same part number for manufacturing. Flange 76 and flange 77 may be placed in abutting relation with one another to enable creation of a bolted joint. It can further be noted from FIG. 3 that gate 50 includes an arcuate forward edge 78 and an arcuate back edge 79 each extending between first hinge element 68 and second hinge element 70. Arcuate forward edge 78 may define a forward plane 400, and arcuate back edge 79 may define a back plane 500. Forward plane 400 and back plane 500 may intersect to form a line that is collinear with hinge axis 54. In a practical implementation strategy an angle 100 defined between forward plane 400 and back plane 500 may be equal to about 90 degrees.

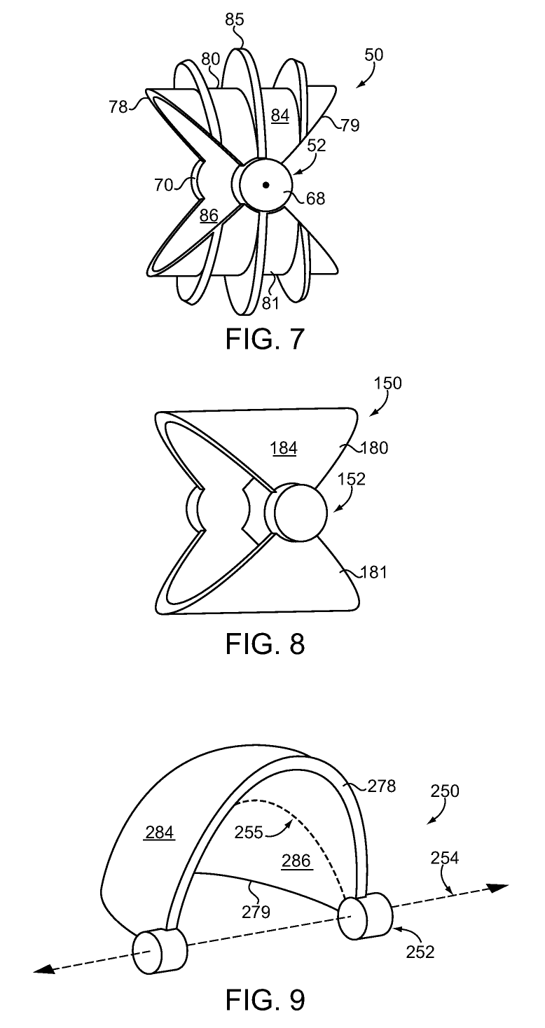

Referring also now to FIG. 7, there is shown gate 50 in a diagrammatic view as it might appear apart from other components of shutoff valve 48. Gate 50 may include a double gate having a first gate element 80 that blocks cylindrical pipe section 72 at the closed position and a second gate element 81 that blocks the second cylindrical pipe section 73 at the closed position. It can be seen from FIG. 7 that an arcuate outer surface 84 extends in an arcuate path between hinge element 68 and hinge element 70 and arcuate inner surface 86 extends generally parallel to the path of outer surface 84 from hinge element 68 to hinge element 70. It will be noted that outer surface 84 and inner surface 86 move in generally the same arcuate path circumferentially about hinge axis 54. In the closed position each of outer surface 84 and inner surface 86 is oriented generally transverse to a direction of air flow, and parallel to the direction of air flow in the open position. The disclosed configuration differs from other valve types such as a butterfly valve, where the butterfly valve rotates instead of swings, or certain types of gate valves where the orientations of the flow obstructing surface(s) are generally not changed during adjustment between a closed position and an open position. Each of outer surface 84 and inner surface 86 may also have a generally linear profile in a side view, and fins 85 may project upwardly away from outer surface 84 into a space formed by domed body 74, or in the case of gate element 81 domed body 75. Referring to FIG. 8, there is shown an alternative embodiment of a gate 150 having a first gate element 180 and a second gate element 181 coupled together by way of a hinge 152 and having an outer surface 184 generally the same in shape to outer surface 84, but where no fins are employed.

Turning now to FIG. 9, there is shown another gate 250 suitable for use in a shutoff valve according to the present disclosure. Gate 250 could be described as a single gate in contrast to the double gates of the embodiments described above. Gate 250 includes or is coupled with a hinge 252 defining a hinge axis 254, an outer surface 284 and an inner surface 286. Each of outer surface 284 and inner surface 286 extends from an arcuate forward edge 278 to an arcuate back edge 279. It can be noted from the illustration in FIG. 9 that arcuate forward edge 278 defines a non-circular arc. Back edge 279 will likewise be understood to define a non-circular arc. In a practical implementation strategy the arc defined by forward edge 278 and the arc defined by back edge 279 may each be a parabolic arc. Gate 250 may be structured such that an imaginary line upon inner surface 286 extending between the respective hinge elements (not numbered) and halfway between forward edge 278 and back edge 279 may form a circular arc. It can therefore be appreciated that a shape of gate 250 may be such that parabolic arcs are formed at the forward edge 278 and back edge 279, but a circular arc at approximately a midpoint between forward edge 278 and back edge 279. It has been discovered that the parabolic shape of forward edge 278 and back edge 279 enables fluidly sealing or substantially fluidly sealing with a cylindrical pipe section such as the cylindrical pipe sections 72 and 73 used in valve housings according to embodiments of the present disclosure. Another way to understand this principle is that a line of sealing formed between gate 250 and a valve housing may have a parabolic shape at forward edge 278 and back edge 279. These principles and the disclosed geometry can also be seen in other gate embodiments according to the present disclosure. It should thus be appreciated that the description herein of any single one of the embodiments of the present disclosure can be taken to apply to any other one of the embodiments of the present disclosure except where indicated otherwise or apparent from the context.

### INDUSTRIAL APPLICABILITY

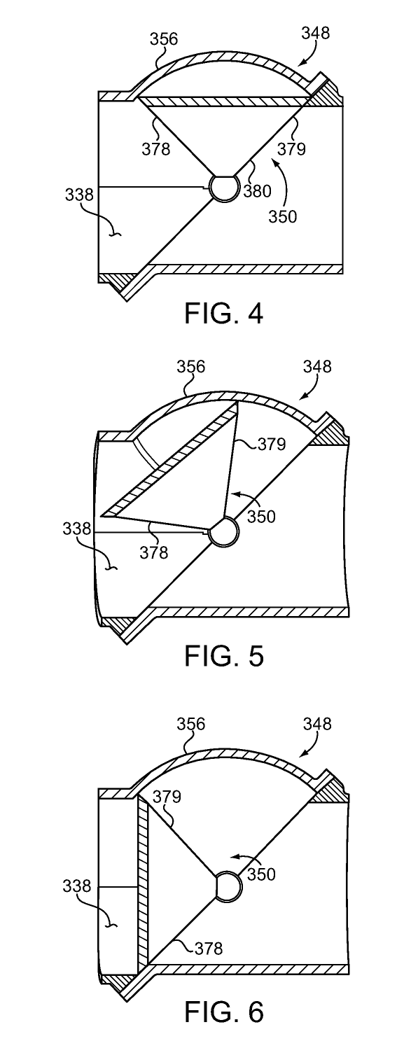

Referring to the drawings generally, but in particular now to FIG. 4, FIG. 5, and FIG. 6, there is shown a shutoff valve 348 according to one embodiment, whose operation can be understood generally as applicable to any of the embodiments contemplated herein. Shutoff valve 348 includes a valve housing 356 defining a fluid passage or fluid flow path 338, and includes a gate 350 having a gate element 380 with an arcuate forward edge 378 and an arcuate back edge 379. In FIG. 4, gate 350 is shown as it might appear during operating a machine system such as machine system 10 during normal operation. Fluid is conveyed through flow path 338 to supply air to a machine such as machine 10. When conditions are detected that make shutting off fluid flow to an associated machine desirable, such as shutting off a flow of air to engine 14, gate 350 may be swung from an open position to a closed position within the fluid conduit as described herein. At FIG. 5 gate 350 is shown as it might appear having been swung approximately halfway from the open position depicted in FIG. 4 to the closed position depicted in FIG. 6. When gate 350 is in the closed position approximately as shown in FIG. 6 each of forward edge 378 and back edge 379 may be in contact with or positioned very close to valve housing 356 to significantly restrict and potentially completely block fluid flow through fluid passage 338. In an engine application the shutting off of air flow can shut down the engine in response. Although only a single gate element is depicted in FIG. 4, it will be appreciated that a double gate embodiment such as those described and otherwise contemplated herein will function in a generally analogous manner, but instead of forming seals between a single forward edge and back edge of a single gate element additional seals would be formed between a second gate element and a valve housing.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A machine system comprising:
a machine;
a fluid conduit defining a fluid flow path, the fluid flow path extending between an inlet and an outlet fluidly connected with the machine;
a shutoff valve including a gate, and a hinge defining a hinge axis within the fluid flow path and supporting the gate at a location that is spaced radially outward of the hinge axis; and
the gate being swingable through the fluid flow path and about the hinge axis between an open position, at which the fluid inlet is in fluid communication with the fluid outlet, and a closed position, at which the gate blocks the fluid communication to interrupt a flow of fluid through the fluid conduit to the machine.

2. The machine system of claim 1 wherein the shutoff valve includes a valve housing, and a fluid passage extending through the valve housing between an upstream valve housing end and a downstream valve housing end and forming a segment of the fluid flow path, and wherein the fluid passage is unobstructed by the gate at the open position.

3. The machine system of claim 2 wherein the valve housing includes a first housing piece and a second housing piece, and the hinge includes a first hinge element and a second hinge element positioned upon opposite sides of the fluid flow path and each clamped between the first housing piece and the second housing piece.

4. The machine system of claim 3 wherein at least one of the first housing piece and the second housing piece includes a domed body, and the gate is swingable in an arcuate path that is parallel to an arc defined by a shape of the domed body.

5. The machine system of claim 3 wherein each one of the first housing piece and the second piece includes a pipe section, for coupling with the fluid conduit, a domed body, and a connecting flange, for attaching to the connecting flange of the other of the first housing piece and the second housing piece.

6. The machine system of claim 3 wherein the first housing piece and the second housing pieces are substantially identical.

7. The machine system of claim 1 wherein the machine includes an engine, and the fluid conduit includes an air intake conduit for supplying air to the engine.

8. The machine system of claim 6 further comprising a pump coupled with the engine.

9. A shutoff valve for a machine system comprising:
a valve housing including an upstream end and a downstream end, and a fluid passage being formed in the valve housing and extending between the upstream end and the downstream end;
a hinge positioned at least partially within the valve housing and defining a hinge axis that extends through the fluid passage; and
a gate supported by the hinge at a location radially outward of the hinge axis and between the upstream end and the downstream end, and the gate being swingable through the fluid passage and about the hinge axis between an open position and a closed position, and the gate blocking fluid communication through the fluid passage at the closed position to interrupt a flow of fluid through the shutoff valve to the machine.

10. The valve of claim 9 wherein the hinge includes a first hinge element and a second hinge element mounted within the valve housing upon a first side and a second side of the fluid passage, respectively, and wherein the gate includes an arcuate forward edge and an arcuate back edge each extending between the first hinge element and the second hinge element.

11. The valve of claim 10 wherein the arcuate forward edge defines a forward plane, and the arcuate back edge defines a back plane, and wherein the forward plane and the back plane intersect to form a line that is collinear with the hinge axis.

12. The valve of claim 11 wherein an angle between the forward plane and the back plane is about 90 degrees.

13. The valve of claim 11 wherein each of the arcuate forward edge and the arcuate back edge defines a non-circular arc.

14. The valve of claim 10 wherein the valve housing includes a domed body, and the gate is swingable in an arcuate path that is parallel to an arc defined by a shape of the domed body.

15. The valve of claim 14 wherein the valve housing includes a first housing piece and a second housing piece that is substantially identical to the first housing piece.

16. The valve of claim 14 wherein the first housing piece includes a first pipe section forming the upstream end, and the second housing piece includes a second pipe section forming the downstream end, and wherein the gate includes a double gate having a first gate element blocking the first pipe section at the closed position and a second gate element blocking the second pipe section at the closed position.

17. A method of operating a machine system comprising:
conveying a fluid through a flow path formed by a fluid conduit coupled with a machine;
swinging a gate of a shutoff valve from an open position to a closed position within the fluid conduit about a hinge defining a hinge axis that extends through the flow path; and
shutting off the flow of fluid to the machine by way of the swinging of the gate from the open position to the closed position.

18. The method of claim 17 wherein the conveying of the fluid includes conveying the fluid through a housing of the shutoff valve without obstruction from the gate so long as the gate is positioned at the open position.

19. The method of claim 18 wherein the machine includes an engine and the conveying of the fluid includes conveying air to the engine, and further comprising shutting down the engine in response to the shutting off of the flow of fluid.

20. The method of claim 17 wherein the swinging of the gate further includes swinging each of a forward gate element and a back gate element to the closed position, such that the forward gate element and the back gate element block a fluid outlet and a fluid inlet in a housing of the shutoff valve.
